(19) United States
(12) Patent Application Publication
(10) Pub. No.: US 2026/0212263 A1
(43) Pub. Date: Jul. 23, 2026

(54) MACHINE-LEARNING FOR CONTENT INTERACTION

(71) Applicant: EQUIFAX INC., Atlanta, GA (US)

(72) Inventors: Cuizhen Shen, Duluth, GA (US); Sean Ippolito, Atlanta, GA (US); Arunkumar Ranganathan, Atlanta, GA (US)

(21) Appl. No.: 19/143,243

(22) PCT Filed: Dec. 29, 2022
(86) PCT No.: PCT/US2022/082563

§ 371 Date: Jun. 25, 2025

(51) Int. Cl. G06N 20/00

(52) U.S. Cl. CPC G06N 20/00

(57) ABSTRACT

A system can generate content recommendations and facilitate interactions using machine-learning. The system can receive a request from a provider entity. The system can receive entity data and interaction data associated with a target entity. The system can generate at least a first graph structure and a second graph structure. The system can generate a linked graph structure based on the first graph structure and the second graph structure. The system can determine among a plurality of operations, one or more target operations to perform on data included in the linked graph structure. The system can execute using a trained machine-learning model, the target operations to generate a content recommendation for facilitating an interaction. The system can provide a responsive message based on the content recommendation usable to facilitate the interaction.

### TECHNICAL FIELD

The present disclosure relates generally to machine-learning techniques for facilitating interaction. More specifically, but not by way of limitation, this disclosure relates to machine-learning techniques for recommending content and facilitating interactions.

### BACKGROUND

Various interactions are performed frequently through an interactive computing environment such as a website, a user interface, etc. The interactions may involve transferring resources for or otherwise based on content. The content may include computing resources or other products or services desired by an entity that may transfer the resources. Determining content to recommend to the entity for subsequent interactions may be difficult, and facilitating subsequent interactions may be difficult with other techniques that may not involve machine-learning.

### SUMMARY

Various aspects of the present disclosure provide systems and methods for recommending content for facilitating and interaction using machine-learning techniques. The system can include a processor and a non-transitory computer-readable medium that includes instructions are executable by the processor to cause the processor to perform various operations. The system can receive a request from a provider entity. The request can include a request to provide content recommendation to facilitate an interaction between the provider entity and a target entity. The system can receive entity data and interaction data associated with the target entity. The system can generate, based on the entity data and the interaction data, at least a first graph structure and a second graph structure. The system can generate, based on the first graph structure and the second graph structure, a linked graph structure. The system can determine, among a set of operations, one or more target operations to perform on data included in the linked graph structure. The system can execute, using a trained machine-learning model, the one or more target operations on the linked graph structure to generate a content recommendation to facilitate the interaction. The system can provide a responsive message based on the content recommendation usable to facilitate the interaction.

In other aspects, a method can be used to recommend content for facilitating and interaction using machine-learning techniques. A request can be received from a provider entity. The request can include a request to provide content recommendation to facilitate an interaction between the provider entity and a target entity. Entity data and interaction data associated with the target entity can be received. At least a first graph structure and a second graph structure can be generated based on the entity data and the interaction data. A linked graph structure can be generated based on the first graph structure and the second graph structure. One or more target operations to perform on data included in the linked graph structure can be determined among a set of operations. The one or more target operations can be executed on the linked graph structure, and using a trained machine-learning model, to generate a content recommendation to facilitate the interaction. A responsive message based on the content recommendation and usable to facilitate the interaction can be provided.

In other aspects, a non-transitory computer-readable medium can include instructions that are executable by a processing device for causing the processing device to perform various operations. The operations can include receiving a request from a provider entity. The request can include a request to provide content recommendation to facilitate an interaction between the provider entity and a target entity. The operations can include receiving entity data and interaction data associated with the target entity. The operations can include generating, based on the entity data and the interaction data, at least a first graph structure and a second graph structure. The operations can include generating, based on the first graph structure and the second graph structure, a linked graph structure. The operations can include determining, among a set of operations, one or more target operations to perform on data included in the linked graph structure. The operations can include executing, using a trained machine-learning model, the one or more target operations on the linked graph structure to generate a content recommendation to facilitate the interaction. The operations can include providing a responsive message based on the content recommendation usable to facilitate the interaction.

This summary is not intended to identify key or essential features of the claimed subject matter, nor is it intended to be used in isolation to determine the scope of the claimed subject matter. The subject matter should be understood by reference to appropriate portions of the entire specification, any or all drawings, and each claim.

The foregoing, together with other features and examples, will become more apparent upon referring to the following specification, claims, and accompanying drawings.

### BRIEF DESCRIPTION OF DRAWINGS

FIG. 1 is a block diagram depicting an example of a computing environment in which content can be recommended and an interaction can be facilitated using machine-learning techniques according to certain aspects of the present disclosure.

FIG. 2 is a flow chart depicting an example of a process for recommending content and facilitating an interaction using machine-learning according to certain aspects of the present disclosure.

FIG. 3 is a flow chart depicting an example of a process for controlling access to a computing environment using machine-learning according to certain aspects of the present disclosure.

FIG. 4 is a schematic depicting an example of an architecture of a machine-learning model that can recommend content and facilitate an interaction according to certain aspects of the present disclosure.

FIG. 5 is a diagram depicting an example of a graph structure according to certain aspects of the present disclosure.

FIG. 6 is a block diagram depicting an example of a computing system suitable for implementing aspects of the techniques and technologies presented herein.

### DETAILED DESCRIPTION

Certain aspects and examples of the present disclosure relate to recommending content for an entity and facilitating an interaction with the entity using machine-learning, which can improve the functioning of a computing device performing the interaction. For example, machine-learning techniques can reduce an amount of computational resources, such as computer memory, processing power, processing time, and the like, used to understand or perform the interaction or recommend the content. Additionally, access control to computational resources, such as online computer memory, online computational processing power, computing environments, and the like, can be improved using the machine-learning techniques. For example, the machine-learning techniques can be used to determine a likelihood of fraud or other negative consequences in response to providing computational resources to the entity, for example in response to providing the recommended content, facilitating the interaction, and the like.

Certain aspects described herein for recommending content to an entity and facilitating an interaction with the entity using machine-learning can address one or more issues identified above. For example, a machine-learning model can be trained to generate content recommendations, to facilitate or otherwise control an interaction, to control access to a computing environment, and the like with respect to a target entity. The target entity may include an individual, such as a consumer or a user of a user computing device, and the interaction can be between the target entity and a provider entity such as a provider of goods or services. The content recommendations may include (i) content in which the target entity may be interested, (ii) one or more likelihoods or other scores indicating whether the target entity may be interested in interacting with the provider entity, and other suitable information for the content recommendations. The trained machine-learning model may be trained, for example using supervised learning techniques, semi-supervised learning techniques, unsupervised learning techniques, or a combination thereof, to generate the content recommendations based on integrated data associated with the target entity.

A system, such as a computing system, can receive data associated with the target entity. The data can include (i) entity or identity data, which may include a name, address, account information, and the like relating to the target entity, and (ii) interaction data that includes information relating to previously executed interactions involving the target entity. The system can integrate the entity data and the interaction data. For example, the system can generate one or more graph structures based on the entity data and the interaction data. In one particular example, the system can generate an identity graph, which can represent the target entity, and an interaction graph that can represent interactions of the target entity. The identity graph may include identifying information, such as one or more names, one or more addresses, one or more accounts, one or more license numbers, and the like, relating to the target entity. Additionally or alternatively, the interaction graph may include information associating previously executed interactions to the target entity. For example, the interaction graph may include a set of nodes representing a set of interactions and may group subsets of the set of nodes by identities of entities associated with the set of interactions.

The system may link the identity graph, the interaction graph, or any other graph structure generated by the system. Linking the identity graph and the interaction graph may involve executing one or more graph linking operations such as clustering, label propagation, or the like. In one particular example, the system can generate a set of clusters corresponding to a set of interactions, and the system can generate each cluster of the set of clusters based on a common entity such as a common individual, a common household, or the like. Linking the identity graph and the interaction graph may additionally involve generating a linked graph, or an integrated graph, that represents the linked data such as the set of clusters. The system can use the linked graph, or the integrated graph, to generate the content recommendations.

In some examples, the system can receive a request from a client, for example via a client computing system, to generate the content recommendations. The client may include a provider entity or other entity that may be interested in content recommendations relating to the target entity. The system may receive the entity data and the interaction data, and generate one or more graph structures, a linked graph structure, or a combination thereof, in response to receiving the request from the client. In some examples, the system may periodically generate the one or more graph structures, or update existing graph structures for the target entity. Based on the request, the system can determine a set of target operations to perform on the one or more graphs structures, or data included therein. For example, if the request includes a request to determine content to present to the target entity, the system may determine to use a target operation, such as a supervised learning technique, that may be able to generate accurate predictions for the content to present to the target entity. In another example, if the request includes a request to determine a set of entities interested in interacting with the client, the system may determine to use a target operation or set of operations that may be able to generate accurate predictions for the set of entities.

The set of target operations may be executed by a trained machine-learning model. In some examples, the trained machine-learning model can include a set of layers that may be trained via supervised training techniques, semi-supervised training techniques, unsupervised training techniques, or a combination thereof. In one particular example, the trained machine-learning model may include an ingestion layer (e.g., to receive the linked data, etc.), a generation layer, and an output layer. The generation layer may be trained using a combination of supervised training techniques, semi-supervised training techniques, and unsupervised training techniques. In other examples, the trained machine-learning model may include a set of generation layers such as a supervised learning layer, a semi-supervised learning layer, an unsupervised learning layer, and the like. The supervised learning layer may be trained or otherwise able to perform supervised learning operations such as survival analysis and time-series based supervised learning. The semi-supervised learning layer may be trained or otherwise able to perform supervised learning operations such as graph mining. The unsupervised learning layer may be trained or otherwise able to perform unsupervised learning operations such as hierarchical clustering and cosine distance similarity, etc.

The trained machine-learning model may execute the set of target operations to generate one or more probabilities, one or more segmentations, other suitable outputs from the set of target operations, or any combination thereof. The one or more probabilities may include probabilities of the target entity interacting with the content recommendation, of the target entity interacting with the provider entity, or the like. The one or more segmentations may include groups of one or more entities that may be interested in interacting with the provider entity, groups of one or more entities that may be interested in the content recommendation, or the like. In some examples, the trained machine-learning model may integrate the one or more probabilities, the one or more segmentations, the other suitable outputs, etc. to generate the content recommendation in response to the request received from the client. The content recommendation may include content items, entity recommendations, and the like that can be to be provided to the client. In some examples, the content items may include products or services such as computational resources, financial services, and the like. Additionally or alternatively, the entity recommendations may include a list of entities, such as consumers or other individuals, that may be interested in content items provided by the client.

The system can provide the content recommendations to one or more remote computing devices. For example, the system can transmit a responsive message to a remote computing device to facilitate an interaction. In such examples, the system can generate the responsive message that includes the content recommendation and transmit the responsive message to the remote computing device, such as a user computing device or client computing device, to initiate, offer, or otherwise facilitate the interaction with respect to the target entity. In another example, the system can transmit a responsive message to a remote computing device to control access to an interactive computing environment. The system can generate content recommendations, which may involve performing one or more risk assessment operations with respect to offered content and the target entity, and the content recommendations can be used to control access to the interactive computing environment. For example, the content recommendations may include a risk assessment that indicates providing computational resources to the target entity is above a predefined risk threshold (e.g., due to financial constraints, fraud concerns, etc.), and the responsive message that includes the content recommendations can be transmitted to the remote computing device to control access to the interactive computing environment. Thus, the content recommendations, included in the responsive message, can improve interaction facilitation and the technical field of access control for a computing environment.

These illustrative examples are given to introduce the reader to the general subject matter discussed here and are not intended to limit the scope of the disclosed concepts. The following sections describe various additional features and examples with reference to the drawings in which like numerals indicate like elements, and directional descriptions are used to describe the illustrative examples but, like the illustrative examples, should not be used to limit the present disclosure.

Operating Environment Example for Recommending Content and Facilitating Interactions with Machine-Learning

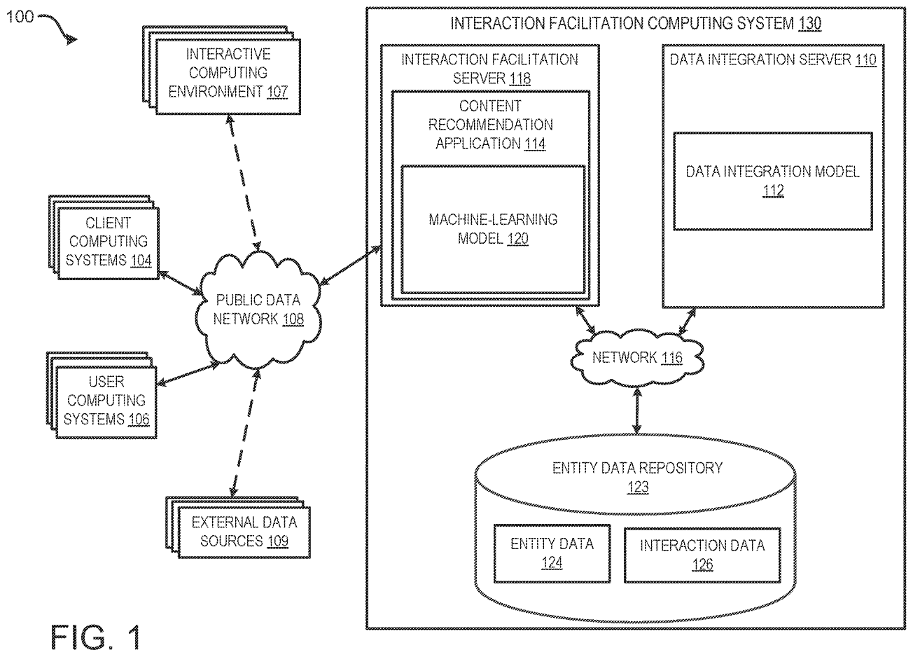

Referring now to the drawings, FIG. 1 is a block diagram depicting an example of a computing environment 100 in which content can be recommended and an interaction can be facilitated using machine-learning techniques according to certain aspects of the present disclosure. FIG. 1 depicts examples of hardware components of an interaction facilitation computing system 130, according to some aspects. The interaction facilitation computing system 130 can be a specialized computing system that may be used for processing large amounts of data (e.g., for controlling access to the interactive computing environment 107, for recommending content, etc.) using a large number of computer processing cycles. The interaction facilitation computing system 130 can include an interaction facilitation server 118 for recommending content and facilitating interactions that may be based on the recommended content. In some examples, the interaction facilitation computing system 130 can include other suitable components, servers, subsystems, etc.

The interaction facilitation server 118 can include one or more processing devices that can execute program code, such as a machine-learning model 120, a content recommendation application 114, and the like. The program code can be stored on a non-transitory computer-readable medium or other suitable medium. The machine-learning model 120 can execute one or more processes to generate one or more content recommendations for use in facilitating an interaction with the entity, controlling access of the entity to the interactive computing environment 107, and the like. In some examples, the content recommendations may include recommendations of content to provide, or offer, to the target entity, a set of entities including the target entity to which to provide, or offer, particular content, or the like. The interaction facilitation server 118 can then perform operations for initiating, or otherwise facilitating, the interaction or access control operations for validating received data such as authentication data received from the user computing systems 106, the client computing systems 104, etc. For example, the interaction facilitation server 118 can provide the content recommendations to the entity, such as via a user interface displayed on the user computing systems 106, the client computing systems 104, or the like, can perform one or more risk assessment operations, can initiate an interaction based on the content recommendations, or other suitable operations. The risk assessment operations may involve determining whether the entity is a legitimate entity, whether a request to access the interactive computing environment 107, or to initiate the interaction, is a legitimate request, or the like. Initiating the interaction may involve providing, in response to generating the content recommendations, access to the interactive computing environment 107, computational resources, and the like to the entity.

In some aspects, the machine-learning model 120 can use data received from one or more external data sources 109, an entity data repository 123, or other suitable sources. The data can include entity data 124, interaction data 126, or other data relating to the entity. The entity data 124 may include an entity name, an entity address, an entity employment history, and the like, and the interaction data 126 may include historical interaction data associated with the entity. Examples of historical interaction data may include a provider entity with which the entity initiated or participated in an interaction, resource amounts or types associated with the interaction, and the like. The entity data 124 and the interaction data 126 can be determined, for example by the interaction facilitation computing system 130, and stored in one or more network-attached storage units on which various repositories, databases, or other structures are stored. Examples of these data structures can include the entity data repository 123. In some examples, the entity data 124, the interaction data 126, or a combination thereof can be used to train the machine-learning model 120. The machine-learning model 120 can be trained to generate the content recommendations, to control access to the interactive computing environment 107 using the content recommendations, or the like.

The interaction facilitation computing system 130 may additionally include a data integration server 110 that includes, or that can execute, a data integration model 112. The data integration model 112 may be embodied in program code and stored on, or otherwise accessible by, the data integration server 110. The data integration server 110 may access data, such as the entity data 124 and the interaction data 126, via network 116, the public data network 108, and the like. Data accessed by the data integration server 110 can be integrated or otherwise processed by the data integration model 112. For example, the data integration model 112 can receive the entity data 124 and the interaction data 126, and the data integration model 112 can generate one or more graph structures and linked graph structures. In one particular example, the data integration model 112 can generate an identity graph for the target entity and an interaction graph for the target entity and can link data between the identity graph and the interaction graph. Linking the data may involve one or more graph linking operations such as clustering, label propagation, and the like. The linked graph structure, or data included therein, can be used, for example by the machine-learning model 120, to generate content recommendations in response to a request from the client computing system 104.

In some examples, a modularity can be defined as a measure to evaluate, for example via Equation 1, a density of links comparing connections from an interaction graph network.

$$Q = \frac{1}{2 m} \sum [ {A}_{i j} - {k}_{i} {k}_{j} ] * d [ {c}_{i} , {c}_{j} ] \qquad ( Equation 1 )$$

In Equation 1, Aᵢⱼ can be edge weights between interaction event i and interaction event j. The edge weights can be represented by frequency. Additionally, kᵢ and kⱼ can be a sum of weights of edges, and m can be the sum of all edges in the network. And, cᵢ and cⱼ can be nodes of communities identified in the network. A modularity of a community can be a difference between the sum of edge weights within the community and the sum of edge weights between the communities. In some examples, d[cᵢ, cⱼ] can be a distance computation to evaluate the community modularity using, for example, a cosine similarity function:

$$Similarity = \sum \frac{[ {c}_{i} , {c}_{j} ]}{\sqrt{{c}_{i}} * \sqrt{{c}_{j}}} \qquad ( Equation 2 )$$

Network-attached storage units may store a variety of different types of data organized in a variety of different ways and from a variety of different sources. For example, the network-attached storage unit may include storage other than primary storage located within the interaction facilitation server 118 that is directly accessible by processors located therein. In some aspects, the network-attached storage unit may include secondary, tertiary, or auxiliary storage, such as large hard drives, servers, and virtual memory, among other types of suitable storage. Storage devices may include portable or non-portable storage devices, optical storage devices, and various other mediums capable of storing and containing data. A machine-readable storage medium or computer-readable storage medium may include a non-transitory medium in which data can be stored and that does not include carrier waves or transitory electronic signals. Examples of a non-transitory medium may include, for example, a magnetic disk or tape, optical storage media such as a compact disk or digital versatile disk, flash memory, memory devices, or other suitable media.

Furthermore, the interaction facilitation computing system 130 can communicate with various other computing systems. The other computing systems can include user computing systems 106, such as smartphones, personal computers, and the like, client computing systems 104, and other suitable computing systems. For example, user computing systems 106 may transmit requests for accessing the interactive computing environment 107 to the client computing systems 104. In response, the client computing systems 104 can send the authentication queries to the interaction facilitation server 118, which can receive the entity data 124 and the interaction data 126 associated with the entity for generating and providing the content recommendations. While FIG. 1 shows that the interaction facilitation computing system 130 and the client computing systems 104 are separate systems, they can be one system. For example, the interaction facilitation computing system 130 can be a part of, such as included in, the client computing systems 104.

As illustrated in FIG. 1, the interaction facilitation computing system 130 may interact with the client computing systems 104, the user computing systems 106, other computing systems, or a combination thereof via one or more public data networks 108 to facilitate interactions between users of the user computing systems 106, the client computing systems 104, the interactive computing environment 107, or any combination thereof. For example, the interaction facilitation computing system 130 can facilitate an interaction, such as based on content recommendations generated by the machine-learning model 120, between the client computing systems 104 and the user computing system 106. The interaction facilitation computing system 130 may provide the content recommendations to the user computing systems 106 and may authenticate a request by the user computing systems 106 to initiate the interaction. In some examples, the interaction facilitation computing system 130 can additionally communicate with third-party systems (e.g., the external data sources 109), for example to receive additional entity data, interaction data, or the like, through the public data network 108. For example, the third-party systems can provide additional entity data or interaction data (e.g., not included in the entity data 124 or the interaction data 126) associated with the entity to the interaction facilitation computing system 130.

Each client computing system 104 may include one or more devices such as individual servers or groups of servers operating in a distributed manner. A client computing system 104 can include any computing device or group of computing devices operated by a seller, lender, or other suitable entity that can provide content such as products or services. The client computing system 104 can include one or more server devices. The one or more server devices can include or can otherwise access one or more non-transitory computer-readable media.

The client computing system 104 can further include one or more processing devices that can be capable of providing an interactive computing environment 107, such as a user interface, etc., that can perform various operations. The interactive computing environment 107 can include executable instructions stored in one or more non-transitory computer-readable media. The instructions providing the interactive computing environment 107 can configure one or more processing devices to perform the various operations. In some aspects, the executable instructions for the interactive computing environment can include instructions that provide one or more graphical interfaces. The graphical interfaces can be used by a user computing system 106 to access various functions of the interactive computing environment 107. For instance, the interactive computing environment 107 may transmit data to and receive data, such as via the graphical interface, from a user computing system 106 to shift between different states of the interactive computing environment 107, where the different states allow one or more electronics interactions between the user computing system 106 and the client computing system 104 to be performed.

In some examples, the client computing system 104 may include other computing resources associated therewith, which may not be illustrated in FIG. 1, such as server computers hosting and managing virtual machine instances for providing cloud computing services, server computers hosting and managing online storage resources for users, server computers for providing database services, and others. The interaction between the user computing system 106, the client computing system 104, and the interaction facilitation computing system 130, or any suitable sub-combination thereof may be performed through graphical user interfaces, such as the user interface, presented by the interaction facilitation computing system 130, the client computing system 104, other suitable computing systems of the computing environment 100, or any suitable combination thereof. The graphical user interfaces can be presented to the user computing system 106. Application programming interface (API) calls, web service calls, or other suitable techniques can be used to facilitate interaction between any suitable combination or sub-combination of the client computing system 104, the user computing system 106, and the interaction facilitation computing system 130.

A user computing system 106 can include any computing device or other communication device operated by a user or entity, such as a consumer or a customer. The user computing system 106 can include one or more computing devices such as laptops, smartphones, and other personal computing devices. The user computing system 106 can include executable instructions stored in one or more non-transitory computer-readable media. The user computing system 106 can additionally include one or more processing devices able to execute program code to perform various operations. In various examples, the user computing system 106 can allow a user to access certain online services or other suitable products, services, computing resources, or recommendations thereof from a client computing system 104, to engage in mobile commerce with the client computing system 104, to obtain controlled access to electronic content, such as the interactive computing environment 107, hosted by the client computing system 104, etc.

For instance, a target entity can use the user computing system 106 to engage in an electronic interaction with the client computing system 104 via the interactive computing environment 107. The interaction facilitation computing system 130 may receive a request, for example via the client computing system 104, to generate one or more recommendations of content based on the electronic interaction, based on potential subsequent electronic interactions associated with the target entity, or a combination thereof. The interaction facilitation server 118 may execute the machine-learning model 120 to generate and provide the content recommendations to the client computing system 104, which may provide, via the interactive computing environment 107 or other suitable user interface, the content recommendations to the target entity. In some examples, the request may involve a risk assessment request that causes the interaction facilitation computing system 130, or any component thereof, to determine whether to provide access to recommended content based on risk assessment indicators associated with the target entity.

In some aspects, an interactive computing environment 107 implemented through the client computing system 104 can be used to provide access to various online functions. As a simplified example, a user interface or other interactive computing environment 107 provided by the client computing system 104 can include electronic functions for requesting computing resources, online storage resources, network resources, database resources, or other types of resources. In another example, a website or other interactive computing environment 107 provided by the client computing system 104 can include electronic functions for obtaining one or more financial services, such as an asset report, management tools, credit card application and transaction management workflows, electronic fund transfers, etc.

A user computing system 106 can be used to request access to the interactive computing environment 107 provided by the client computing system 104. The client computing system 104 can submit a request, for example in response to a request made by the user computing system 106 to access the interactive computing environment 107, or in response to the request for content recommendations, for risk assessment to the interaction facilitation computing system 130 and can selectively grant or deny access to various electronic functions based on risk assessment performed by the interaction facilitation computing system 130. Based on the risk assessment, or any suitable score determined therefrom, generated by the interaction facilitation server 118, the interaction facilitation computing system 130, the client computing system 104, or a combination thereof can determine whether to grant the access request of the user computing system 106 to certain features of the interactive computing environment 107.

In some examples, determining to grant access to the interactive computing environment 107 may involve generating access permission for the entity. The access permission can include, for example, cryptographic keys used to generate valid access credentials or decryption keys used to decrypt access credentials. The client computing system 104 can also allocate resources to the target entity and provide a dedicated web address for the allocated resources to the user computing system 106, for example, by adding the user computing system 106 in the access permission. With the obtained access credentials or the dedicated web address, the user computing system 106 can establish a secure network connection to the interactive computing environment 107 hosted by the client computing system 104 and access the resources via invoking API calls, web service calls, HTTP requests, other suitable mechanisms or techniques, etc.

In some examples, the interaction facilitation computing system 130 may determine whether to grant, challenge, or deny an access request made by the user computing system 106 for accessing the interactive computing environment 107. For example, based on the content recommendations, the risk assessment or associated scores, the interaction facilitation computing system 130 can determine that the target entity is a legitimate entity that made the access request and may authenticate the request. In other examples, the interaction facilitation computing system 130 can challenge or deny the access attempt if the interaction facilitation computing system 130, or any component thereof, determines that the target entity may not be a legitimate entity.

Each communication within the computing environment 100 may occur over one or more data networks, such as a public data network 108, a network 116 such as a private data network, or some combination thereof. A data network may include one or more of a variety of different types of networks, including a wireless network, a wired network, or a combination of a wired and wireless network. Examples of suitable networks include the Internet, a personal area network, a local area network (“LAN”), a wide area network (“WAN”), or a wireless local area network (“WLAN”). A wireless network may include a wireless interface or a combination of wireless interfaces. A wired network may include a wired interface. The wired or wireless networks may be implemented using routers, access points, bridges, gateways, or the like, to connect devices in the data network.

The number of devices depicted in FIG. 1 is provided for illustrative purposes. Different numbers of devices may be used. For example, while certain devices or systems are shown as single devices in FIG. 1, multiple devices may instead be used to implement these devices or systems. Similarly, devices or systems that are shown as separate, such as the interaction facilitation server 118 and the entity data repository 123, may be instead implemented in a single device or system. Similarly and as discussed above, the interaction facilitation computing system 130 may be a part of the client computing system 104.

### Techniques for Recommending Content and Facilitating an Interaction Using Machine-Learning

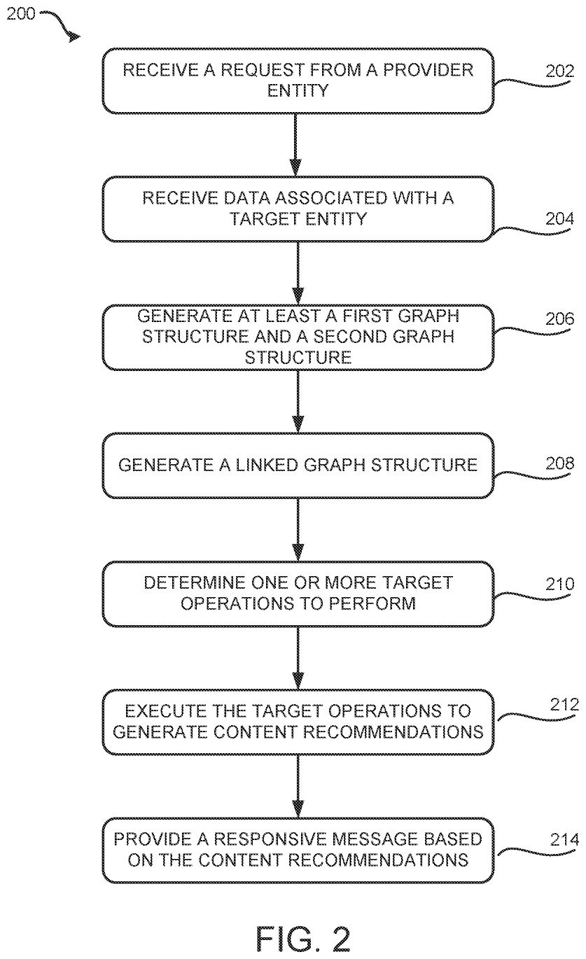

FIG. 2 is a flow chart depicting an example of a process 200 for recommending content and facilitating an interaction using machine-learning according to certain aspects of the present disclosure. One or more computing devices, such as the interaction facilitation computing system 130, can implement operations depicted and described with respect to FIG. 2 by executing suitable program code such as the machine-learning model 120. For illustrative purposes, the process 200 is described with reference to certain examples depicted in the figures. Other implementations, however, are possible.

At block 202, the process 200 involves receiving a request from a provider entity. The interaction facilitation computing system 130 can receive a request from the provider entity, for example via the client computing system 104, etc., and the request may include a request for one or more content recommendations relating to a target entity. In some examples, the provider entity may be a new provider entity with which the interaction facilitation computing system 130 has not previously communicated. The target entity may include a user, such as a user of the user computing system 106, of content provided by the provider entity. The one or more content recommendations may include recommendations of content to provide, or offer, to the target entity, a set of entities including the target entity to which to provide, or offer, particular content, or the like. In a particular example, the provider entity may include a computational resource provider, and the content recommendation may include a type of computational resource to offer a historical user of resources provided by the computational resource provider.

At block 204, the process 200 involves receiving data associated with the target entity. In some examples, the interaction facilitation computing system 130 may receive the data corresponding to the target entity or associated with other entities associated with the target entity. In a particular example, the interaction facilitation computing system 130 can receive data about the target entity and about other entities residing at the same location as the target entity. The received data may include identity data, interaction data, and other data relating to the target entity, associated entities, or a combination thereof. For example, the received data may include one or more names, one or more addresses, one or more social security numbers or portions of social security numbers, one or more license numbers, one or more account numbers, one or more email addresses, one or more devices or device identifications, one or more phone numbers, or other data that can be used to at least partially identify the target entity. Additionally or alternatively, the received data may include interaction data of previously executed or initiated interactions involving the target entity or associated entities. In a particular example, the interaction data can include a number of previously initiated interactions, an amount of resources (e.g., total or per interaction, etc.) associated with the previously initiated interactions, provider entities associated with the previously initiated interactions, and the like.

At block 206, the process 200 involves generating at least a first graph structure and a second graph structure based on the received data. In some examples, the first graph structure may be or include an identity graph, and the second graph structure may be or include an interaction graph. The interaction facilitation computing system 130, or any component thereof such as the data integration model 112, etc., may generate the identity graph based on identity data included in the received data and may generate the interaction graph based on interaction data included in the received data, though other types of graphs based on other sets of data may be generated by the interaction facilitation computing system 130. In some examples, the first graph structure and the second graph structure may each include a set of nodes and a set of connections. Each connection of the set of connections may indicate a relationship between nodes connected by the connection, and each node of the set of nodes may correspond to an entity, an interaction involving a particular entity, or the like.

At block 208, the process 200 involves generating a linked graph structure. The interaction facilitation computing system 130 can link the first graph structure and the second graph structure to generate the linked graph structure. For example, the interaction facilitation computing system 130 can perform label propagation, clustering, or other suitable graph linking operations to generate the linked graph structure based at least on the first graph structure and the second graph structure. In some examples, the interaction facilitation computing system 130 may link the data included in the first graph structure and the second graph structure to generate linked data. The linked graph structure, or the linked data, may indicate an identity of the target entity and may associate the identity of the target entity with interactions initiated or otherwise involving the target entity. In some examples, the interaction facilitation computing system 130 may generate the linked graph structure, or the linked data, in response to receiving the request (e.g., at the block 202). In other examples, the interaction facilitation computing system 130 may generate the linked graph structure, or the linked data, periodically or otherwise asynchronously with respect to the request.

In some examples, in response to the interaction facilitation computing system 130 receiving information from a new provider entity, one or more machine-learning algorithms or other techniques can be used to identify “look-a-likes” mapped to the linked graph structure. A unique manifold learning technique can be applied to define structure segmentations, which can use a force graph layout algorithm in low-dimensional space. An attractive force between two vertices yᵢ and yⱼ can be determined by:

$$\frac{- 2 ab {‖ {y}_{i} - {y}_{j} ‖}_{2}^{2 ( b - 1 )}}{1 + {‖ y ( i ) - y ( j ) ‖}_{2}^{2}} ω ( ( {x}_{i} m {x}_{j} ) ( {y}_{i} - {y}_{j} ) ) \qquad ( Equation 3 )$$

After the manifold-learning-based segmentation is determined, contractive autoencoders can be used to learn manifolds across the linked graph network to search for “look-alikes.” For example, a loss function can be applied for a contractive autoencoder:

$$- {\sum }_{k} ( {x}_{k}^{t} log ( {\hat{x}}_{k}^{t} ) + ( 1 - {\hat{x}}_{k}^{t} ) log ( 1 - {\hat{x}}_{k}^{t} ) ) + λ \vert \vert {\sum }_{j , k} {( \frac{δ h ( {x}_{j}^{t} )}{δ {x}_{k}^{t}} )}^{2} \qquad ( Equation 4 )$$

At block 210, the process 200 involves determining one or more target operations to perform. The target operations can be performed, for example by the interaction facilitation computing system 130 or any component thereof (e.g., the machine-learning model 120), on the linked graph structure, or any data included therein. The target operations can be selected from a set of target operations that may include attribute random forest, survival analysis, uniform manifold approximation and projection, hierarchical clustering, cosine distance similarity, auto-encoder, and graph-mining operations including page rank and Louvin clustering analysis. Other target operations, such as other supervised learning operations, other semi-supervised learning operations, other unsupervised learning operations, or the like, can be selected by the interaction facilitation computing system 130. The interaction facilitation computing system 130 may select the target operations based on the request received from the provider entity. For example, if the request indicates that a content item is requested to be presented to the target entity, the interaction facilitation computing system 130 can select target operations able to generate predictions for the content item.

In some examples, the machine-learning model 120 can be used to predict content, recommend content, and the like. For example, the machine-learning model 120 can involve time-series analysis with a recursive neural network applied to learn previous entity interactions for predicting subsequent interactions. In examples in which xₜ, is a most recent observation where t′<t:

$${\hat{x}}_{t} = {m}_{t} {x}_{t} + ( 1 - {m}_{t} ) ( {γ}_{x ( i )} {x}_{t} , + ( 1 - {γ}_{x ( i )} ) ) \hat{x} \qquad ( Equation 5 )$$

Additionally or alternatively, the machine-learning model 120 can involve a boosting implementation of negative binomial regression for quantity, etc. The associated negative binomial distribution and the associated loss function can be or include, respectively:

$$f ( k ; δ , p ) = {{C}_{k}^{k + γ - 1} ( 1 - p )}^{k} {p}^{γ} \qquad ( Equation 6 )$$

$$L = arg {min}_{s} ϕ ( {y}_{i} \hat{F} ( {x}_{i} + s ) \qquad ( Equation 7 )$$

At block 212, the process 200 involves executing the target operations to generate content recommendations. In some examples, the target operations may be performed by a trained machine-learning model such as the machine-learning model 120. The interaction facilitation computing system 130 can input data into the machine-learning model 120 to cause the machine-learning model 120 to execute the target operations. For example, the interaction facilitation computing system 130 can input the linked data, the entity data, the identity data, the interaction data, or any combination thereof into the machine-learning model 120 to cause the machine-learning model 120 to execute the target operations. In a particular example, the interaction facilitation computing system 130 can input the linked graph structure, or the linked data included therein, into the machine-learning model 120.

In some examples, executing the target operations can involve outputting the content recommendations. The machine-learning model 120 can execute the target operations to generate one or more predictions, segmentations, and the like, and an output layer of the machine-learning model 120 can integrate or otherwise suitably combine the outputs to generate the content recommendations. The content recommendations can include a particular content item to provide or offer to the target entity, a set of entities (e.g., associated with the target entity) that may be interested in a particular content item from the provider entity, and the like.

At block 214, the process 200 involves providing a responsive message based on the content recommendations. The interaction facilitation computing system 130 can generate the responsive message to include the content recommendations, and the interaction facilitation computing system 130 can transmit the responsive message to a remote computing system. For example, the interaction facilitation computing system 130 can transmit the responsive message to the provider entity, for example via the client computing system 104, to facilitate an interaction between the provider entity and the target entity, to facilitate potential interactions between the set of entities and the provider entity, and the like. In a particular example, the interaction facilitation computing system 130 can transmit the responsive message to a remote computing system, such as the client computing system 104, external computing systems, or the like, to control access to an interactive computing environment such as the interactive computing environment 107. The responsive message may additionally include results from one or more risk assessment operations that can be used to grant, deny, or challenge access of the target entity to the interactive computing environment 107 or other computational resources provided by the provider entity.

### Techniques for Controlling Access to a Computing Environment Using Machine-Learning

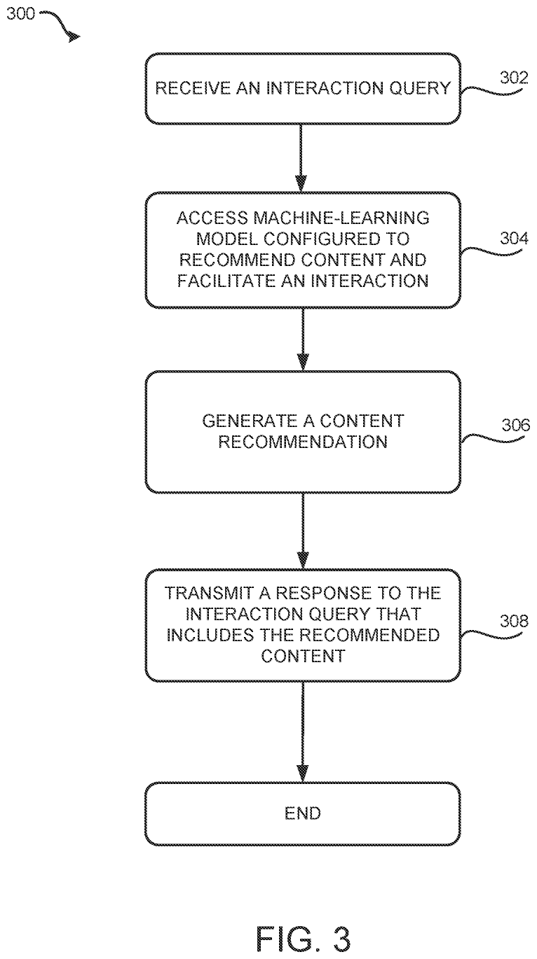

FIG. 3 is a flow chart depicting an example of a process 300 for controlling access to a computing environment using machine-learning according to certain aspects of the present disclosure. One or more computing devices, such as the interaction facilitation computing system 130, can implement operations depicted and described with respect to FIG. 3 by executing suitable program code such as the machine-learning model 120. For illustrative purposes, the process 300 is described with reference to certain examples depicted in the figures. Other implementations, however, are possible.

At block 302, the process 300 involves receiving an interaction query for a target entity from a remote computing device, such as a client computing system 104. The interaction query can also be received by the interaction facilitation server 118 from a remote computing device associated with an entity authorized to transmit the interaction request on behalf of an entity associated with the client computing system 104.

At block 304, the process 300 involves accessing a machine-learning model 120 trained to generate content recommendations associated with the target entity. In some examples, the machine-learning model 120 may additionally or alternatively be or include one or more proprietary models, one or more heuristics models, one or more simulation models, or any combination thereof. Content recommendations can be generated based on entity data 124 and interaction data 126 determined or received by the interaction facilitation computing system 130. As described in more detail with respect to FIG. 1 above, examples of the entity data 124 and the interaction data 126 can include real-time data and historical data associated with the target entity that describes prior actions or interactions involving the target entity, such as information that can be obtained from credit files or records, financial records, consumer records, online interactions, or other data about the activities or characteristics of the entity, etc., behavioral traits of the target entity, demographic traits of the target entity, or any other traits that may be used to generated content recommendations associated with the target entity.

At block 306, the process 300 involves generating content recommendations for the target entity based on the entity data 124 and the interaction data 126 using the machine-learning model 120. The entity data 124 and the interaction data 126, or any suitable entity data determined or received therefrom, can be used as input to the machine-learning model 120. The content recommendations associated with the target entity can be generated by extracting features from received or produced entity data 124 and interaction data 126, an integration thereof, etc. The output of the machine-learning model 120 can include the content recommendations for the target entity.

At block 308, the process 300 involves transmitting a responsive message based on the content recommendations, which may be determined at the block 306. In some examples, the interaction facilitation server 118, or any other suitable module, model, or computing device, can transmit the responsive message to a computing device, such as the client computing system 104, or any other suitable computing device that can control an interaction between the user computing system 106 and the client computing system 104, or that can control access to the interactive computing environment 107. The responsive message can vary based on the content recommendations. For example, the responsive message may include the content recommendations for display to the target entity. Additionally or alternatively, the responsive message may indicate that the target entity, which may submits an access request to access the interactive computing environment 107, is a legitimate entity and may recommend granting access to the interactive computing environment 107 based on the access request. In other examples, the responsive message may indicate that the entity is unknown or otherwise not associated with legitimate activity and may recommend challenging or denying the access request.

In some examples, the responsive message may be generated and transmitted based on the content recommendations. For example, the machine-learning model 120 can generate one or more content recommendations for the target entity, and the interaction facilitation server 118 can generate the responsive message based on the content recommendations. The content recommendations can include a recommendation for the target to engage in an interaction to acquire content, can include a likelihood of the target entity engaging in the interaction, other suitable information, or any combination thereof. Additionally or alternatively, the interaction facilitation server 118 can determine, based on the content recommendations generated by the machine-learning model 120, whether to recommend granting, challenging, or denying an access request, for accessing the interactive computing environment 107, submitted by the target entity. In some examples, the interaction facilitation computing system 130 can generate and transmit the responsive message to grant, challenge, or deny the access request based on the content recommendations generated by the machine-learning model 120.

### Architecture for the Machine-Learning Model

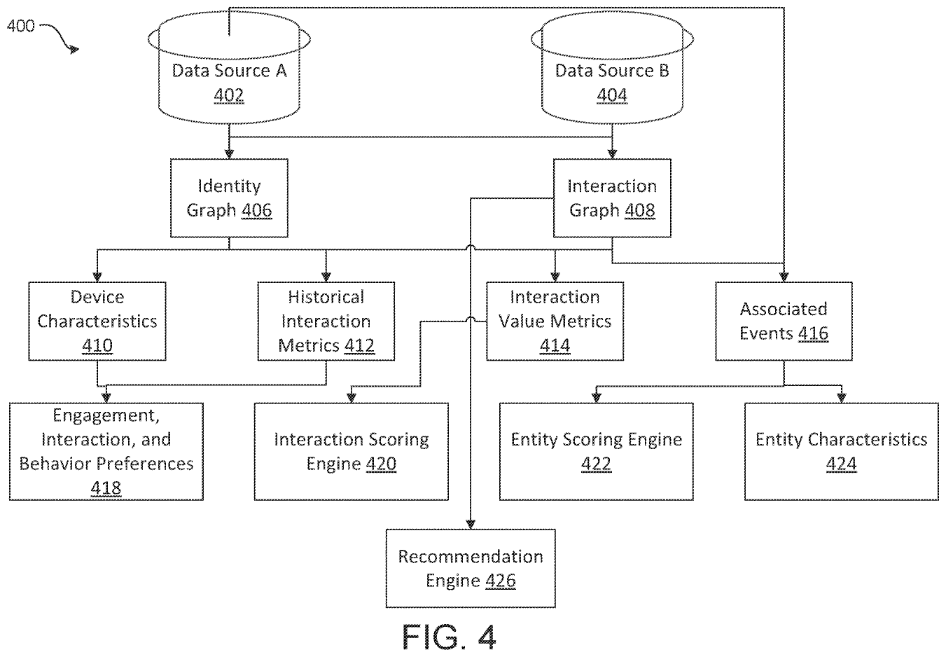

FIG. 4 is a schematic depicting an example of an architecture 400 of a machine-learning model 120 that can recommend content and facilitate an interaction according to certain aspects of the present disclosure. In some examples, the machine-learning model 120 may receive data from a first data source, such as data source A 402, and a second data source such as data source B 404. Data source A 402 may include identity data or other entity data about the target entity, and data source B 404 may include interaction data associated with the target entity. The data sources may include other suitable data that can be input into the machine-learning model 120 for generating the content recommendations in response to the request from the provider entity.

As illustrated, the machine-learning model 120 includes an identity graph 406 and an interaction graph 408. In some examples, the machine-learning model 120 can generate the identity graph 406 and the interaction graph 408 based on data received from data source A 402 and data source B 404. In other examples, the machine-learning model 120 may receive the identity graph 406, the interaction graph 408, or a combination thereof from a separate computing system or from a separate component (e.g., the data integration model 112) of the interaction facilitation computing system 130. The identity graph 406 may be or include a graph structure that includes a set of nodes corresponding to characteristics about the target entity, associated entities (e.g., family or household members), or a combination thereof. For example, the nodes of the identity graph 406 may include one or more names, one or more physical or virtual addresses, one or more phone numbers, one or more account numbers, and the like relating to the target entity or entities associated therewith. In some examples, the machine-learning model 120, or other suitable model such as the data integration model 112, can perform a label propagation operation on the identity graph 406 to determine or otherwise define identities indicated by the identity graph 406. Additionally, the interaction graph 408 may be or include a graph structure that includes a set of nodes corresponding to events associated with the target entity or any other entity associated therewith. For example, the nodes of the interaction graph 408 may include one or more previously executed or initiated interaction involving the target entity or associated entities. In some examples, the machine-learning model 120, or other suitable model such as the data integration model 112, can perform a clustering operation, such as a graph-based hierarchical clustering operation, on the interaction graph 408 to associate interactions indicated by the interaction graph 408 with the target entity or associated entities.

The machine-learning model 120 may include one or more generation layers. For example, the machine-learning model 120 may include one generation layer that is able to perform the operations of the machine-learning model 120 (e.g., discussed below). In other examples, the machine-learning model 120 may include multiple generation layers that are able to perform one or more of the operations of the machine-learning model 120. As illustrated, the machine-learning model 120 can include modules, layers, or models including device characteristics 410, historical interaction metrics 412, interaction value metrics 414, associated events 416, engagement, interaction, and behavior preferences 418, an interaction scoring engine 420, an entity scoring engine 422, entity characteristics 424, and a recommendation engine 426. The machine-learning model 120 can include other suitable modules, layers, or models for generating content recommendations and the like.

The device characteristics 410 can involve unsupervised learning techniques. For example, the device characteristics 410 can used linked data from the identity graph 406 and the interaction graph 408 to generate device characteristics micro-segments. The device characteristics 410 can involve associating communities (e.g., groups of nodes) from the linked data with a digital identity hash value. Based on the digital identity hash value, the device characteristics 410 can determine device related metrics. For example, a device-holding position, a button-clicking strength, a screen-swiping direction, a typing speed, a keyboard usage, a geo-movement collection, and the like can be determined via the device characteristics 410. In some examples, the device characteristics 410 can perform unsupervised nearest neighbor learning operations. The device characteristics 410 can output the determined device characteristics for subsequent use by other modules of the machine-learning model 120.

The historical interaction metrics 412 can involve determining inferred digital activity associated with the target entity or associated entities. For example, communities from the linked data can be associated with the digital identity hash value. The historical interaction metrics 412 can determine entity digital interaction metrics such as where (or with whom) the target entity initiate interactions, particular content items that interest the target entity, and the like. The historical interaction metrics 412 can additionally determine device usage interactions such as days and times the target entity initiates an interaction, a device or application used to initiate the interaction, an origination path for resources used to initiate the interaction, and the like. The historical interaction metrics 412 can output the inferred digital activity for subsequent use by other modules of the machine-learning model 120.

The interaction value metrics 414 can involve determining perceived or inferred values for the provider entity and associated with the target entity or associated entities. For example, communities from the linked data can be associated with the digital identity hash value. The interaction value metrics 414 can determine entity value metrics including a likelihood of the target entity repeating an interaction with the provider entity, whether the target entity is enrolled in any programs provided by the provider entity, how often the entity visits the provider entity physically or virtually, resources transferred to the provider entity by the target entity, and the like. Additionally, the interaction value metrics 414 may determine negative entity value metrics including a likelihood of the target entity canceling an initiated interaction, the target entity lacking resources to engage in the initiated interaction, and the like. The interaction value metrics 414 can output interaction values for subsequent use by other modules of the machine-learning model 120.

The associated events 416 can involve determining milestone events in the life of the target entity or the associated entities. For example, communities from the linked data can be associated with the digital identity hash value. The associated events 416 can determine life event metrics including new contacts made by the target entity, new residence acquired by the target entity, new employment history associated with the target entity, travel planned by the target entity, and other activities participated in by the target entity. In some examples, the associated events 416 can determine the above for one or more entities associated with the target entity. The associated events 416 can output associated events for subsequent use by other modules of the machine-learning model 120.

The engagement, interaction, and behavior preferences 418 can receive, as input, at least the determined device characteristics from the device characteristics 410 and the inferred digital activity from the historical interaction metrics 412. A digital engagement score, which may indicate how the target entity engages with provider entities via digital engagements, can be determined via a negative binomial link function or other suitable operations. Additionally or alternatively, a digital behavioral segmentation can be generated via divisive clustering operations, uniform manifold learning operations, autoencoder operations, or the like. In a particular example, a divisive hierarchical clustering can be generated based on the determine device characteristics and the inferred digital activity. The divisive hierarchical clustering can be input into the manifold learning model to generate clusters, and a deep-learning-based autoencoder can be applied to learn cluster patterns indicated by the clusters.

Additionally or alternatively, natural language processing can be used by the engagement, interaction, and behavior preferences 418. For example, a content preference prediction engine can be executed by the engagement, interaction, and behavior preferences 418 to determine content preferences of the target entity. In a particular example, content categories can be generated by applying natural language processing topic modelling, or the like, based on content descriptions or content representative interactions with the target entity. Associate rule mining can be used to derive content preferences for the target entity. Additionally, k-nearest neighbor operations or a Bayesian network to recommend the content preference. Additionally or alternatively, the engagement, interaction, and behavior preferences 418 can use survival analysis models to determine the content preferences.

The interaction scoring engine 420 can receive, as input, at least the interaction values from the interaction value metrics 414. The interaction scoring engine 420 can include other suitable engines such as a negative interaction engine, a repeat interaction engine, a prospect score engine, a content recommendation success engine, a historical trend engine, and the like. The negative interaction engine may execute an xgboost algorithm to determine a likelihood of the target entity canceling a pending interaction, reversing a completed interaction, or the like. The repeat interaction engine may execute a random forest operation to determine a likelihood of the target entity engaging in an interaction to acquire the recommended content. The prospect score engine may execute the xgboost algorithm to determine whether the target entity, or associated entities, may be interested in interacting with the recommended content. The content recommendation success engine may execute a recursive neural network to determine a likelihood of the target entity accepting an offer for the recommended content. The historical trend engine may execute a multivariable gradient boosting machine, or the like, to determine historical trends, and inferences thereof, of interactions involving the target entity. Each of the engines described above, or any subset thereof, may output one or more probabilities, one or more segmentations, or a combination thereof.

The entity scoring engine 422 can receive, as input, at least the associated events from the associated events 416. The entity scoring engine 422 may include or execute various estimators and segments including a resource estimator, a resource segment, a resource transfer estimator, a loyalty score estimator, and an entity value segment. The resource estimator may execute a Poisson regression to determine an estimate of resources associated with the target entity. The resource segment may execute a k-means operation to determine the resource segmentation of the target entity. The resource transfer estimator may execute a Bayesian model to determine a likelihood or amount of resources involved in interactions associated with the target entity. The loyalty score estimator may execute optimal binning with inverse tangent operations to determine a likelihood of the target entity repeating an interaction with the provider entity. The entity value segment may execute a k-means operation to determine value gained by the provider entity in response to engaging in an interaction with the target entity. Each of the estimators or segments described above, or any subset thereof, may output one or more probabilities, one or more segmentations, or a combination thereof. The entity characteristics 424 can also receive, as input, at least the associated events from the associated events 416. The entity characteristics 424 can execute a k-means operation to determine a lifestyle segment or life-event triggers for the target entity.

The recommendation engine 426 can receive, as input, at least the interaction graph 408. In some examples, the recommendation engine 426 can be or include a graph-mining-based recommendation engine. The recommendation engine 426 can use a node-embedding algorithm for dimension reduction. Additionally or alternatively, the recommendation engine 426 can use page rank operations, closeness operations, and between operations for determining whether the target entity, or one or more of the associated entities, is an influencing entity. The influencing entity may cause associated entities to engage in interactions, etc. In some embodiments, the outputs of the modules of the machine-learning model 120 can be combined to generate the content recommendations. For example, the probabilities, segmentations, and recommendations generated by the modules of the machine-learning model 120 can be combined to form the content recommendations. Additionally or alternatively, the combined outputs of the modules of the machine-learning model 120 can be used to generate the content recommendations.

### Example of a Graph Structure

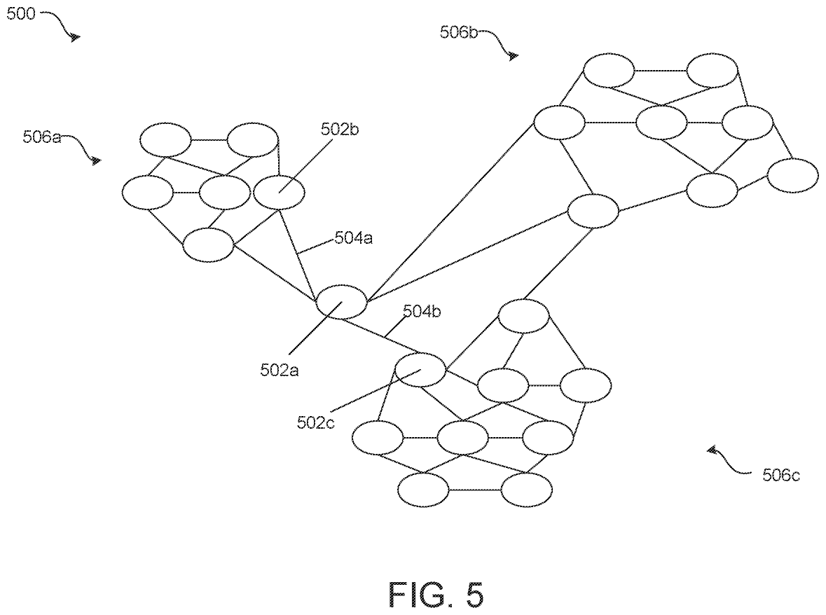

FIG. 5 is a diagram depicting an example of a graph structure 500 according to certain aspects of the present disclosure. In some examples, the graph structure 500 can include a set of nodes, which may include representative nodes 502a-c, and a set of connections, which may include representative connections 504a-b. While illustrated as a cluster graph with nodes and connections, the graph structure 500 can include other types of graphs such as directed acyclic graphs, or the like.

Each node of the graph structure 500 may represent an entity, an entity characteristic, an interaction, an interaction characteristic, or other suitably information. For example, if the graph structure 500 is an identity graph, the nodes of the graph structure may correspond to the target entity, characteristics of the target entity, and the like. In a particular example in which the graph structure 500 is an identity graph, the node 502a may represent the target entity, and the nodes 502b-c may represent distinct characteristics about the entity since the nodes 502b-c are connected to the node 502a via the connections 504a-b.

The connections of the graph structure 500 may indicate relationships between different nodes. For example, if the graph structure 500 is an interaction graph, the node 502a may represent an interaction between the target entity and a particular entity, and the nodes 502b-c may additionally represent an interaction between the target entity and separate entities. The connection 504a may indicate that the interaction represented by the node 502a may relate to the interaction represented by the node 502b. For example, the node 502a and the node 502b may represent interactions with a particular provider entity. Additionally, the connection 504b may indicate that the interaction represented by the node 502a may relate to the interaction represented by the node 502c. For example, the node 502a and the node 502c may represent interactions involving a particular type of content, etc.

In some examples, the interaction facilitation computing system 130 may generate the graph structure 500. Additionally or alternatively, the interaction facilitation computing system 130 can link the graph structure 500, or any data included therein, with a separate graph structure or data included therein. The interaction facilitation computing system 130 can perform one or more clustering operations on the graph structure 500, or to generate the graph structure 500. For example, based on received data, such as the entity data 124, the interaction data 126, or a combination thereof, the interaction facilitation computing system 130 can adjust the graph structure 500 to include clusters 506a-c. Each cluster of the clusters 506a-c may represent a type of interaction, a particular entity, or the like. For example, the cluster 506a may represent the target entity, etc., and nodes included in the cluster 506a may represent characteristics of the target entity, interactions that involve the target entity, or the like. The interaction facilitation computing system 130 may perform graph mining operations on the graph structure 500 to, at least in-part, generate the content recommendations in response to receiving the request from the provider entity.

### Example of Computing System

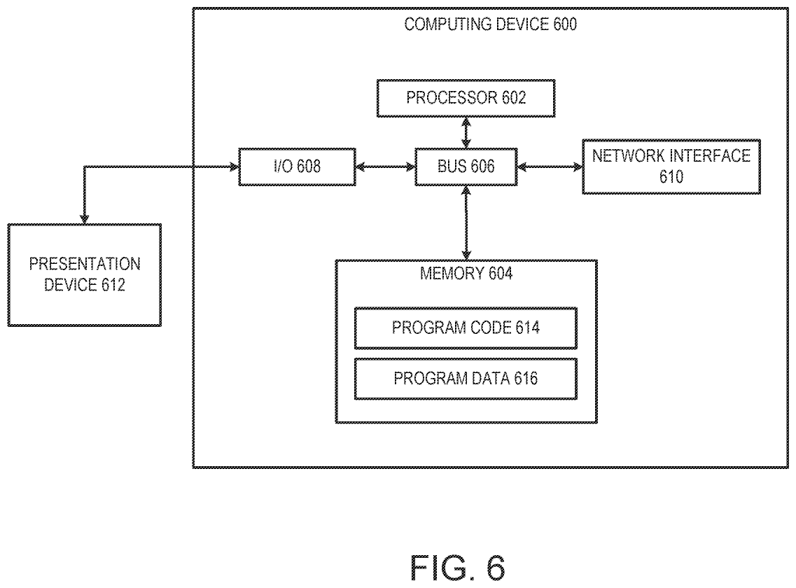

Any suitable computing system or group of computing systems can be used to perform the operations for the machine-learning operations described herein. For example, FIG. 6 is a block diagram depicting an example of a computing device 600, which can be used to implement the interaction facilitation server 118 or other suitable components of the computing environment 100. The computing device 600 can include various devices for communicating with other devices in the computing environment 100, as described with respect to FIG. 1. The computing device 600 can include various devices for performing one or more data consolidation or validation (or other suitable) operations described above with respect to FIGS. 1-4.

The computing device 600 can include a processor 602 that is communicatively coupled to a memory 604. The processor 602 can execute computer-executable program code stored in the memory 604, can access information stored in the memory 604, or both. Program code may include machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing or receiving information, data, arguments, parameters, or memory contents. Information, arguments, parameters, data, etc., may be passed, forwarded, or transmitted via any suitable means including memory sharing, message passing, token passing, network transmission, among others.

Examples of a processor 602 can include a microprocessor, an application-specific integrated circuit (ASIC), a field-programmable gate array (FPGA), or any other suitable processing device. The processor 602 can include any suitable number of processing devices, including one. The processor 602 can include or communicate with a memory 604. The memory 604 can store program code that, when executed by the processor 602, causes the processor 602 to perform the operations described herein.

The memory 604 can include any suitable non-transitory computer-readable medium. The computer-readable medium can include any electronic, optical, magnetic, or other storage device capable of providing a processor with computer-readable program code or other program code. Non-limiting examples of a computer-readable medium can include a magnetic disk, memory chip, optical storage, flash memory, storage class memory, ROM, RAM, an ASIC, magnetic storage, or any other medium from which a computer processor can read and execute program code. The program code may include processor-specific program code generated by a compiler or an interpreter from code written in any suitable computer-programming language. Examples of suitable programming language can include Hadoop, C, C++, C#, Visual Basic, Java, Python, Perl, JavaScript, ActionScript, etc.

The computing device 600 may also include a number of external or internal devices such as input or output devices. For example, the computing device 600 is illustrated with an input/output interface 608 that can receive input from input devices or provide output to output devices. A bus 606 can also be included in the computing device 600. The bus 606 can communicatively couple one or more components of the computing device 600.

The computing device 600 can execute program code 614 that can include the machine-learning model 120. The program code 614 for the machine-learning model 120 may be resident in any suitable computer-readable medium and may be executed on any suitable processing device. For example, as depicted in FIG. 6, the program code 614 for the machine-learning model 120 can reside in the memory 604 at the computing device 600 along with the program data 616 associated with the program code 614, such as the entity data 124, the interaction data 126, etc. Executing the machine-learning model 120 can configure the processor 602 to perform the operations described herein.

In some aspects, the computing device 600 can include one or more output devices. One example of an output device can be the network interface device 610 depicted in FIG. 6. A network interface device 610 can include any device or group of devices suitable for establishing a wired or wireless data connection to one or more data networks described herein. Non-limiting examples of the network interface device 610 can include an Ethernet network adapter, a modem, etc.

Another example of an output device can include the presentation device 612 depicted in FIG. 6. A presentation device 612 can include any device or group of devices suitable for providing visual, auditory, or other suitable sensory output. Non-limiting examples of the presentation device 612 can include a touchscreen, a monitor, a speaker, a separate mobile computing device, etc. In some aspects, the presentation device 612 can include a remote client-computing device that communicates with the computing device 600 using one or more data networks described herein. In other aspects, the presentation device 612 can be omitted.

The foregoing description of some examples has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure.

What is claimed is:

1. A system comprising:
a processor; and
a non-transitory computer-readable medium comprising instructions that are executable by the processor to cause the processor to perform operations comprising:
receiving a request from a provider entity, the request including a request to provide content recommendation to facilitate an interaction between the provider entity and a target entity;
receiving entity data and interaction data associated with the target entity;
generating, based on the entity data and the interaction data, at least a first graph structure and a second graph structure;
generating, based on the first graph structure and the second graph structure, a linked graph structure;
determining, among a plurality of operations, one or more target operations to perform on data included in the linked graph structure;
executing, using a trained machine-learning model, the one or more target operations on the linked graph structure to generate a content recommendation to facilitate the interaction; and
providing a responsive message based on the content recommendation usable to facilitate the interaction.

2. The system of claim 1, wherein the first graph structure is an identity graph and the second graph structure is an interaction graph, wherein the identity graph comprises identity data about the target entity, wherein the interaction graph comprises historical interaction data associated with the target entity, and wherein the identity graph and the interaction graph are generatable by integrating the entity data and the interaction data.

3. The system of claim 1, wherein the entity data comprises identity information about the target entity, wherein the identity information comprises name information, account information, and device information associated with the target entity, and wherein the interaction data comprises information about previously executed interactions involving the target entity.

4. The system of claim 3, wherein the operations further comprise:
training, to generate the trained machine-learning model, a machine-learning model by using a supervised training operation, a semi-supervised training operation, and an unsupervised training operation, wherein:
the supervised training operation involves training the machine-learning model with labeled data included in the entity data and in the interaction data;
the semi-supervised training operation involves training the machine-learning model with unlabeled data included in the entity data and in the interaction data; and
the unsupervised training operation involves training the machine-learning model with partially labeled data included in the entity data and in the interaction data.

5. The system of claim 1, wherein the plurality of operations comprises attribute random forest, survival analysis, uniform manifold approximation and projection, hierarchical clustering, cosine distance similarity, auto-encoder, and graph-mining operations including page rank and Louvin clustering analysis.

6. The system of claim 1, wherein the operation of determining the one or more target operations to perform on data included in the linked graph structure comprises:
determining a set of outputs corresponding to the request to provide content recommendation; and
selecting, among the plurality of operations, the one or more target operations based on the set of outputs, wherein the one or more target operations, upon execution, are configured to generate the set of outputs.

7. The system of claim 1, wherein the operation of providing the responsive message based on the content recommendation comprises transmitting, to a remote computing device, the responsive message including the content recommendation for use in controlling access of the target entity to one or more interactive computing environments.

8. A method comprising:
receiving, by a computing device, a request from a provider entity, the request including a request to provide content recommendation to facilitate an interaction between the provider entity and a target entity;
receiving, by the computing device, entity data and interaction data associated with the target entity;
generating, by the computing device and based on the entity data and the interaction data, at least a first graph structure and a second graph structure;
generating, by the computing device and based on the first graph structure and the second graph structure, a linked graph structure;
determining, by the computing device and among a plurality of operations, one or more target operations to perform on data included in the linked graph structure;
executing, by the computing device and using a trained machine-learning model, the one or more target operations on the linked graph structure to generate a content recommendation to facilitate the interaction; and
providing, by the computing device, a responsive message based on the content recommendation usable to facilitate the interaction.

9. The method of claim 8, wherein the first graph structure is an identity graph and the second graph structure is an interaction graph, wherein the identity graph comprises identity data about the target entity, wherein the interaction graph comprises historical interaction data associated with the target entity, and wherein generating at least the first graph structure and the second graph structure comprises generating, by integrating the entity data and the interaction data, the identity graph and the interaction graph.

10. The method of claim 8, wherein the entity data comprises identity information about the target entity, wherein the identity information comprises name information, account information, and device information associated with the target entity, and wherein the interaction data comprises information about previously executed interactions involving the target entity.

11. The method of claim 10, further comprising:
training, by the computing device and to generate the trained machine-learning model, a machine-learning model by using a supervised training operation, a semi-supervised training operation, and an unsupervised training operation, wherein:
the supervised training operation involves training the machine-learning model with labeled data included in the entity data and in the interaction data;
the semi-supervised training operation involves training the machine-learning model with unlabeled data included in the entity data and in the interaction data; and
the unsupervised training operation involves training the machine-learning model with partially labeled data included in the entity data and in the interaction data.

12. The method of claim 8, wherein the plurality of operations comprises attribute random forest, survival analysis, uniform manifold approximation and projection, hierarchical clustering, cosine distance similarity, auto-encoder, and graph-mining operations including page rank and Louvin clustering analysis.

13. The method of claim 8, wherein determining the one or more target operations to perform on data included in the linked graph structure comprises:
determining, by the computing device, a set of outputs corresponding to the request to provide content recommendation; and
selecting, by the computing device and among the plurality of operations, the one or more target operations based on the set of outputs, wherein the one or more target operations, upon execution, are configured to generate the set of outputs.

14. The method of claim 8, wherein providing the responsive message based on the content recommendation comprises transmitting, by the computing device and to a remote computing device, the responsive message including the content recommendation for use in controlling access of the target entity to one or more interactive computing environments.

15. A non-transitory computer-readable medium comprising instructions that are executable by a processing device for causing the processing device to perform operations comprising:
receiving a request from a provider entity, the request including a request to provide content recommendation to facilitate an interaction between the provider entity and a target entity;
receiving entity data and interaction data associated with the target entity;
generating, based on the entity data and the interaction data, at least a first graph structure and a second graph structure;
generating, based on the first graph structure and the second graph structure, a linked graph structure;
determining, among a plurality of operations, one or more target operations to perform on data included in the linked graph structure;
executing, using a trained machine-learning model, the one or more target operations on the linked graph structure to generate a content recommendation to facilitate the interaction; and
providing a responsive message based on the content recommendation usable to facilitate the interaction.

16. The non-transitory computer-readable medium of claim 15, wherein the first graph structure is an identity graph and the second graph structure is an interaction graph, wherein the identity graph comprises identity data about the target entity, wherein the interaction graph comprises historical interaction data associated with the target entity, and wherein the identity graph and the interaction graph are generatable by integrating the entity data and the interaction data.

17. The non-transitory computer-readable medium of claim 15, wherein the entity data comprises identity information about the target entity, wherein the identity information comprises name information, account information, and device information associated with the target entity, wherein the interaction data comprises information about previously executed interactions involving the target entity, and wherein the operations further comprise:
training, to generate the trained machine-learning model, a machine-learning model by using a supervised training operation, a semi-supervised training operation, and an unsupervised training operation, wherein:
the supervised training operation involves training the machine-learning model with labeled data included in the entity data and in the interaction data;
the semi-supervised training operation involves training the machine-learning model with unlabeled data included in the entity data and in the interaction data; and
the unsupervised training operation involves training the machine-learning model with partially labeled data included in the entity data and in the interaction data.

18. The non-transitory computer-readable medium of claim 15, wherein the plurality of operations comprises attribute random forest, survival analysis, uniform manifold approximation and projection, hierarchical clustering, cosine distance similarity, auto-encoder, and graph-mining operations including page rank and Louvin clustering analysis.

19. The non-transitory computer-readable medium of claim 15, wherein the operation of determining the one or more target operations to perform on data included in the linked graph structure comprises:
determining a set of outputs corresponding to the request to provide content recommendation; and
selecting, among the plurality of operations, the one or more target operations based on the set of outputs, wherein the one or more target operations, upon execution, are configured to generate the set of outputs.

20. The non-transitory computer-readable medium of claim 15, wherein the operation of providing the responsive message based on the content recommendation comprises transmitting, to a remote computing device, the responsive message including the content recommendation for use in controlling access of the target entity to one or more interactive computing environments.
